(19) United States
(12) Patent Application Publication
(10) Pub. No.: US 2011/0313611 A1
(43) Pub. Date: Dec. 22, 2011

(54) Tire autolocation system and method using an angular velocity

(75) Inventors: Seung Do An, Gyunggi-do (KR); Jong Woo Han, Seoul (KR); Kang Joo Kim, Gyunggi-do (KR); Kyungno Lee, Seoul (KR); Hae Seung Hyun, Gyunggi-do (KR); Jong Hyeong Song, Gyunggi-do (KR)

(73) Assignee: SAMSUNG ELECTRO-MECHANICS CO., LTD., Gyunggi-do (KR)

(21) Appl. No.: 12/917,929

(22) Filed: Nov. 2, 2010

(30) Foreign Application Priority Data
Jun. 22, 2010 (KR) 102010059234

(51) Int. Cl. G06F 19/00

(52) U.S. Cl. 701/29

(57) ABSTRACT

Disclosed herein are a tire autolocation system and method using an angular sensor.

The present invention includes an air pressure detector and a body control module, wherein the air pressure detector includes an air pressure detecting module detecting air pressure of a tire and angular velocity sensors symmetrically mounted at left and right sides and detecting angular velocity of the tire and the body control module includes a receiver and reads the left/right tires with (+) and (−) angular signals transmitted from the angular velocity sensors through the receiver.

### CROSS REFERENCE TO RELATED APPLICATION

This application claims the benefit of Korean Patent Application No. 10-2010-0059234, filed on Jun. 22, 2010, entitled “A Tire Autolocation System and Method using an Angular Velocity Sensor”, which is hereby incorporated by reference in its entirety into this application.

### BACKGROUND OF THE INVENTION

1. Technical Field

The present invention relates to a tire autolocation system and method using an angular velocity sensor.

2. Description of the Related Art

Currently, cars are being equipped with a tire pressure monitoring system (hereinafter, referred to “TPMS”) that senses tire air pressure mounted on a car and notifies a driver when the tire air pressure falls below a reference value.

Generally, the TPMS includes air pressure detectors mounted on each of the tire wheels to detect the tire air pressure and the locations of the tire and a body control module (BCM) configured to include a receiver that receives signals detected by the air pressure detectors.

In this case, the air pressure detectors are symmetrically mounted in left and right tires and a biaxial (x-axis and y-axis) acceleration sensor is mounted in the tire.

In addition, the body control module receives the values of the air pressure detected from the air pressure detector and the signals for dividing the locations of the tire through the receiver and transmits them to a display apparatus.

Meanwhile, the TPMS includes a low frequency initiator (LFI) in addition to the air pressure detectors and the body control module to perform the autolocation of the tire. The TPMS is classified into 4-LFI TPMS, 3-LFI TPMS, and 2-LFI TPMS, which corresponds to the number of used LFIs and O-LFI TPMS means no LFI.

In this case, in the case of the 0-LFI TPMS without the LFI, a logic for reading the locations of the tire is mounted on the body control module in order to divide the left/right and front/rear locations of the tire.

The reading locations mounted on the body control module determine the left/right locations of the air pressure detector by using a phase difference of the normal directions and tangential directions of the left/right acceleration sensors mounted on the air pressure detectors.

In other words, in the acceleration sensor mounted at the left side of the air pressure detector, the tangential direction leads the normal direction when the tire rotates and in the acceleration sensor mounted at the right side of the air pressure detector, the normal direction leads the tangential direction. The body control module determines the left/right locations of the air pressure detectors by using the above-mentioned method.

However, since a complex logic called phase lead-lag is used to read the left/right locations of the tire using the above-mentioned biaxial (i.e., x-axis and y-axis) acceleration sensor, a lot of power is consumed at the time of reading the left/right locations of the tire and much time is consumed at the time of reading the left/right locations of the tire.

### SUMMARY OF THE INVENTION

The present invention has been made in an effort to provide a tire autolocation system and method using an angular velocity sensor capable of simplifying a reading logic and reducing power consumed at the time of reading and left/right location reading time of a tire by reading left/right locations with (+) and (−) signals of an angular velocity sensor.

Further, the present invention has been made in an effort to provide a tire autolocation system and method using an angular velocity sensor capable of reducing power consumption of a TPMS by controlling the sleep and wakeup operations of the TPMS using a magnitude of a signal transmitted from an angular velocity sensor.

A tire autolocation system using an angular velocity sensor according to a preferred embodiment of the present invention includes: an air pressure detector that includes an air pressure detecting module detecting air pressure of a tire and angular velocity sensors detecting angular velocity of the tire symmetrically mounted at the left and right side; and a body control module that includes a receiver and reads the left and right tires with (+) and (−) angular velocity signals transmitted from the angular velocity sensors through the receiver.

The body control module recognizes a tire equipped with the angular velocity sensor transmitting the (+) angular velocity signal as a right tire and a tire equipped with the angular velocity sensor transmitting the (−) angular velocity signal as a left tire.

The body control module recognizes a tire equipped with the angular velocity sensor transmitting the (−) angular velocity signal as a right tire and a tire equipped with the angular velocity sensor transmitting the (+) angular velocity signal as a left tire.

The body control module controls a tire pressure monitoring system as a sleep mode when the magnitude of the angular velocity signal transmitted from the angular velocity sensor is a reference value or less and wakeups the pressure monitoring system when the magnitude of the angular velocity signal exceeds a reference value.

The body control module detects a radius of the tire by using an air pressure measuring signal transmitted from the air pressure detecting module, measures the revolutions of the tire by using the magnitude of the angular velocity signal transmitted from the angular velocity sensor, and measures velocity of a car by using the radius and revolutions of the tire.

A tire autolocation system using an angular velocity sensor according to a preferred embodiment of the present invention includes: an air pressure detector that includes an air pressure detecting module detecting air pressure of a tire and angular velocity sensors detecting angular velocity of the tire mounted to be symmetrical left and right; and a body control module that includes a receiver and detects a radius of the tire by using an air pressure measuring signal transmitted from the air pressure detecting module through the receiver, measures the revolutions of the tire by using the magnitude of the angular velocity signal transmitted from the angular velocity sensor, and measures velocity of a car by using the radius and revolutions of the tire.

A tire autolocation system using an angular velocity sensor according to a preferred embodiment of the present invention includes: an air pressure detector that includes an air pressure detecting module detecting air pressure of a tire and angular velocity sensors detecting angular velocity of the tire symmetrically mounted in the left and right tires; and a body control module that includes a receiver and controls a tire pressure monitoring system as a sleep mode when the magnitude of the angular velocity signal transmitted from the angular velocity sensor through the receiver is a reference value or less and wakeups the pressure monitoring system when the magnitude of the angular velocity signal exceeds a reference value.

A tire autolocation method using an angular velocity sensor according to a preferred embodiment of the present invention includes: (a) detecting whether the tire is rotated by the angular velocity sensor, when a car starts; (b) measuring the angular velocity of the tire by the angular velocity sensor, when the tire rotates; and (c) detecting the left and right locations of the tire according to (+) and (−) signal signs of the angular velocity measured by the body control module.

Step (a) further includes repeating step (a) when the tire is not rotated.

Step (c) further includes recognizing a tire equipped with the angular velocity sensor transmitting the (+) angular velocity signal as a right tire and a tire equipped with the angular velocity sensor transmitting the (−) angular velocity signal as a left tire

Step (c) further includes recognizing a tire equipped with the angular velocity sensor transmitting the (−) angular velocity signal as a right tire and a tire equipped with the angular velocity sensor transmitting the (+) angular velocity signal as a left tire.

The tire autolocation method using an angular velocity sensor further includes: (d) detecting, by the body control module, a radius of the tire by using an air pressure measuring signal transmitted from the air pressure detecting module; (e) detecting, by the body control module, revolutions of the tire by using the magnitude of the angular velocity signal transmitted from the angular velocity sensor; and (f) measuring, by the body control module, velocity of a car by using the radius and revolutions of the tire.

### BRIEF DESCRIPTION OF THE DRAWINGS

FIG. 1 is a block diagram showing a configuration of a tire autolocation system using an angular velocity sensor according to a preferred embodiment of the present invention;

FIG. 2 is a diagram showing a location and rotational shaft of an angular velocity sensor shown in FIG. 1;

FIG. 3 is a diagram showing a sign and magnitude of a signal of the angular velocity sensor of FIG. 1 when a car is driven; and

FIG. 4 is a flow chart of a tire autolocation method using an angular velocity sensor according to a preferred embodiment of the present invention.

### DESCRIPTION OF THE PREFERRED EMBODIMENTS

The above and other objects, features and advantages of the present invention will be more clearly understood from the following detailed description taken in conjunction with the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention

In the specification, in adding reference numerals to components throughout the drawings, it is to be noted that like reference numerals designate like components even though components are shown in different drawings.

Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

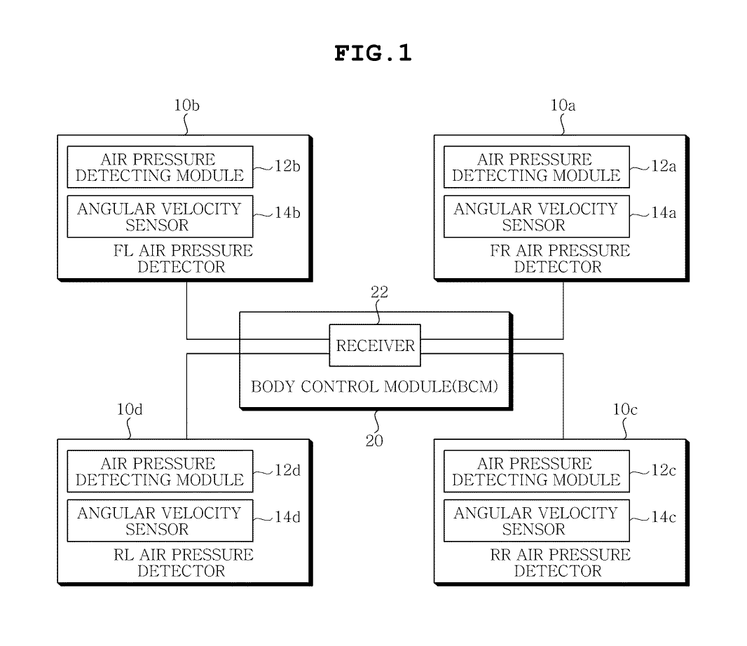

FIG. 1 is a block diagram showing a configuration of a tire autolocation system using an angular velocity sensor according to a preferred embodiment of the present invention.

A tire autolocation system using an angular velocity sensor according to a preferred embodiment of the present invention is configured to include air pressure detecting modules 12a, 12b, 12c, and 12d that detect air pressure of a tire 16, air pressure detectors 10a, 10b, 10c, and 10d that are configured to include angular velocity sensors 14a, 14b, 14c, and 14d detecting angular velocity of the tire 16, a receiver 22, and a body control module 20 that receives signals transmitted from the air pressure detectors 10a, 10b, 10c, and 10d through the receiver 22 to determine air pressure of the tire 16 and left/right and front/rear locations of the tire.

The air pressure detectors 10a, 10b, 10c, and 10d are mounted in each tire 16 to be symmetrical left and right, wherein the front right (FR) air pressure detector 10a is mounted in the front right tire of the car in order to detect the air pressure of the front right tire of the car, the front left (FL) air pressure detector 10b is mounted in the front left tire of the car in order to detect the front left tire of the car, the rear right (RR) air pressure detector 10c that is mounted in the rear right tire of the car in order to detect the air pressure of the rear right tire of the car, and the rear left (RL) air pressure detector 10d is mounted in the rear left tire of the car in order to detect the air pressure of the rear left tire of the car.

The air pressure detecting modules 12a, 12b, 12c, and 12d detecting the air pressure of the tire 16 and the angular velocity sensors 14a, 14b, 14c, and 14d detecting the angular velocity of the tire 16 are installed in each of the air pressure detectors 10a, 10b, 10c, and 10d.

In this case, a temperature detecting module (not shown) for detecting the temperature of the tire 16 may be further provided in each of the air pressure detectors 10a, 10b, 10c, and 10d.

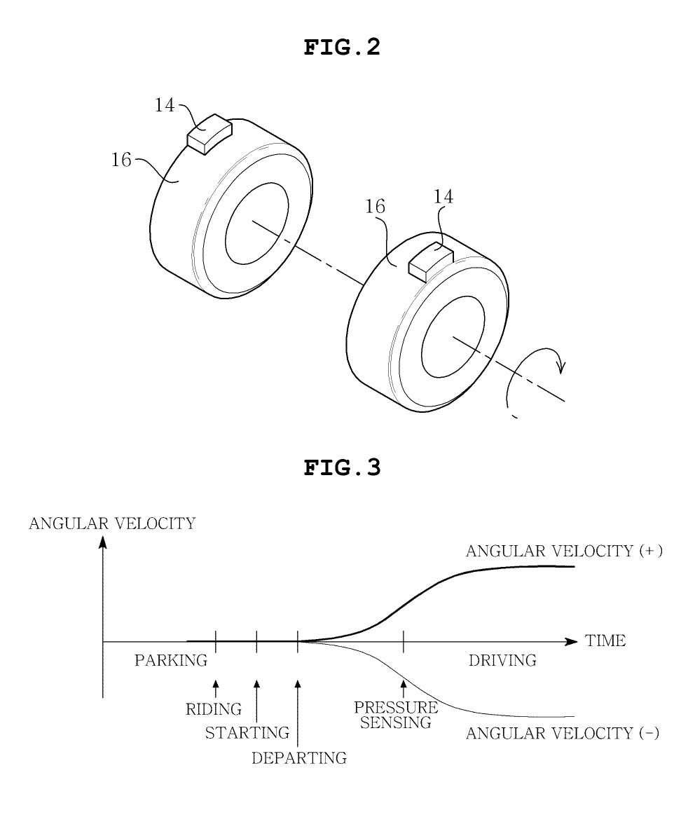

Meanwhile, the angular velocity sensors 14a, 14b, 14c, and 14d are symmetrically mounted in the air pressure detectors 10a, 10b, 10c, and 10d at the left and right sides as shown in FIG. 2 and detect the angular velocity of the tire 16 when the tire 16 rotates along the rotational shaft.

Since the angular velocity sensors 14a, 14b, 14c, and 14d are formed in a uniaxial (for example, a Y-axis gyro sensor) structure, the signals detected by the angular velocity sensors 14a, 14b, 14c, and 14d have (+) and (−) values according to the locations where the angular velocity sensors 14a, 14b, 14c, and 14d are mounted when the tire 16 rotates, as shown in FIG. 3.

In other words, when the tire 16 rotates, a (−) signal is detected in the angular velocity sensors 14a, 14b, 14c, and 14d mounted on the left tire if a (+) signal is detected in the angular velocity sensors 14a, 14b, 14c, and 14d mounted on the right tire and a (+) signal is detected in the angular velocity sensors 14a, 14b, 14c, and 14d mounted on the left tire if a (−) signal is detected in the angular velocity sensors 14a, 14b, 14c, and 14d mounted on the right tire.

In this case, the angular velocity sensors 14a, 14b, 14c, and 14d detects a large angular velocity as velocity is increased and detects the angular velocity having the same magnitude at the same velocity, as shown in FIG. 3.

The body control module 20 receives high frequency signals transmitted from the air pressure detectors 10a, 10b, 10c, and 10d through the receiver 22 to detect the pressure and temperature of the tire 16, the left/right locations and the front/rear locations of the tire 16, and the velocity of the car.

The body control module 20 detects the left/right locations of the tire 16 according to the (+) and (−) signals transmitted from the air pressure detectors 10a, 10b, 10c, and 10d and when the (+) signal is set at any one of the right and left locations, the (−) signal is set to have a location different from a location where the (+) signal is set in the left or right.

In this case, the body control module 20 may detect a radius of the tire 16 by using the known method for detecting the radius of the tire 16 using the transmitted air pressure measuring signals and may measure the revolutions of the tire 16 by using the magnitude of the angular velocity signals transmitted from the angular velocity sensors 14a, 14b, 14c, and 14d.

Meanwhile, the body control module 20 may measure the velocity of the car by using the radius of the tire 16 and the revolutions of the tire 16.

In addition, the body control module 20 may control the sleep and wakeup operations of the TPMS by using the magnitude of the velocity of the car (or magnitude of angular velocity).

In other words, the body control module 20 keeps the TPMS at a sleep mode when the velocity of the car is a reference value (for example, 10 km/h to 30 km/h, preferably, 20 km/h) or less and wakeups the TPMS when the velocity of the car exceeds a reference value, thereby making it possible to reduce power consumption according to the operation of the TPMS.

The body control module 20 may detect the front/rear locations of the tire 16 by using the strength or receiving location of the air pressure signal or the angular velocity signal transmitted from the air pressure detectors 10a, 10b, 10c, and 10d.

In this case, the method enabling the body control module 20 to detect the front/rear location of the tire 16 using the strength or receiving location of the air pressure signal or the angular velocity signal is known and therefore, the detailed description thereof will be omitted.

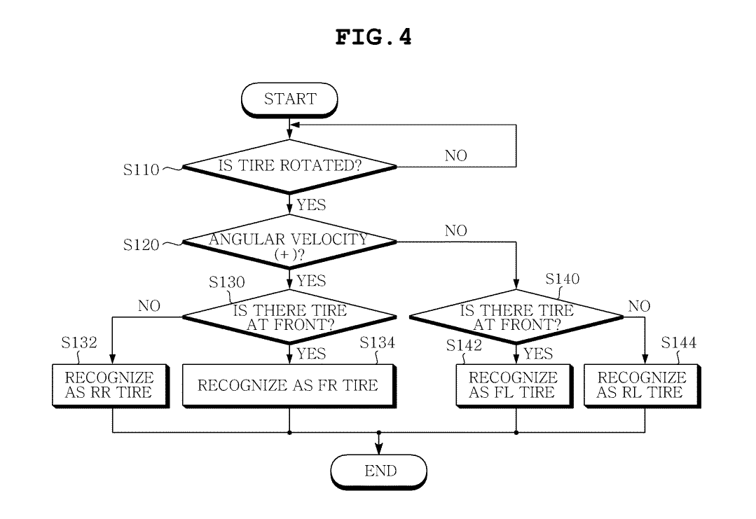

FIG. 4 is a flow chart showing a tire autolocation method using an angular velocity sensor according to a preferred embodiment of the present invention.

In a tire autolocation method using the angular velocity sensor according to a preferred embodiment of the present invention, when a car starts, the angular velocity sensors 14a, 14b, 14c, and 14d detect whether the tire 16 is rotated, that is, the angular velocity (S110).

In this case, the air pressure detectors 10a, 10b, 10c, and 10d including the angular velocity sensors 14a, 14b, 14c, and 14d and the air pressure detecting modules 12a, 12b, 12c, and 12d and the body control module 20 including the receiver 22 are operated only when a car starts.

That is, the air pressure detectors 10a, 10b, 10c, and 10d and the body control module 20 are not operated when a car does not start and the angular velocity sensors 14a, 14b, 14c, and 14d detect the angular velocity of the tire 16 when a car starts.

Meanwhile, when the rotation of the tire 16 is not detected by the angular velocity sensors 14a, 14b, 14c, and 14d, that is, when the car does not move, step S110 is repeated until the tire 16 starts to rotate.

When the rotation of the tire 16 is detected, that is, when the car moves, the body control module 20 reads the left/right locations of the tire 16 according to the sign of the angular velocity signal detected by the angular velocity sensors 14a, 14b, 14c, and 14d (S120).

For example, the body control module 20 recognizes the tire as the right tire when the angular velocity signal is (+) and recognizes the tire as the left tire when the angular velocity signal is (−).

In this case, the body control module 20 may recognize the tire as the left tire when the angular velocity signal is (+) and recognize the tire as the right tire when the angular velocity signal is (−).

In other words, when the (+) angular velocity signal is set as the right tire in the body control module 20, the body control module 20 recognizes the tire in a direction where the (+) signal is transmitted as the right tire and recognizes the tire in a direction where the (−) signal is transmitted as the right tire when the (−) angular velocity signal is set as the right tire.

In addition, the body control module 20 detects the front/rear locations of the tire 16 by using the strength or receiving location of the air pressure signal or the angular velocity signal transmitted from the air pressure detectors 10a, 10b, 10c, and 10d (S130, S132, S134, S140, S142, and S144).

In other words, the body control module 20 recognizes the tire equipped with the corresponding angular velocity sensor as the front tire when the strength of the angular velocity signal is large or the receiving location exists at the front and recognizes as the tire equipped with the corresponding angular velocity sensor as the rear tire when the strength of the angular velocity signal is small or the receiving location exists at the rear.

As described above, the tire autolocation system and method using the angular velocity sensor according to the preferred embodiment of the present invention reads the left and right locations of the tire according to the signal sign of the angular velocity sensor, that is, (+) and (−) by using the uniaxial angular velocity sensor, thereby making it possible to simplify the logic reading the location of the tire and reduce the reading time of the left/right locations of the tire and the power consumption at the reading logic due to the simple reading logic when the left/right locations of the tire are read.

The tire autolocation system and method using an angular velocity sensor according to the preferred embodiment of the present invention can control the sleep and wakeup operations of the TMPS according to the magnitude of the angular velocity signal from the uniaxial angular velocity sensor, thereby making it possible to effectively use the TPMS and reduce the power consumption of the TPMS.

According to the present invention, the left/right locations of the tire are read according to the (+) and (−) signal signs of the angular velocity sensor by using a uniaxial angular velocity sensor, thereby making it possible to simplify the logic reading the locations of the tire and reduce the reading time of the left/right locations of the tire while reducing power consumption at the reading logic because the reading logic is simplified when the left/right locations of the tire are read.

In addition, the present invention can control the sleep and wakeup operations of the TPMS according to the magnitude of the angular velocity signal from the uniaxial angular velocity sensor, thereby making it possible to effectively use the TPMS and reduce the power consumption of the TPMS.

Although preferred embodiments of the present invention have been described, it will be appreciated by those skilled in the art that various modifications and change can be made without departing from the spirit and scope of the appended claims of the present invention. Accordingly, such modifications, additions and substitutions should also be understood to fall within the scope of the present invention.

What is claimed is:

1. A tire autolocation system using an angular velocity sensor, comprising:
an air pressure detector that includes an air pressure detecting module detecting air pressure of a tire and angular velocity sensors detecting angular velocity of the tire mounted to be symmetrical left and right; and
a body control module that includes a receiver and reads the left and right of the tire with (+) and (−) angular velocity signals transmitted from the angular velocity sensors through the receiver.

2. The tire autolocation system using an angular velocity sensors set forth in claim 1, wherein the body control module recognizes a tire equipped with the angular velocity sensor transmitting the (+) angular velocity signal as a right tire and a tire equipped with the angular velocity sensor transmitting the (−) angular velocity signal as a left tire.

3. The tire autolocation system using an angular velocity sensor as set forth in claim 1, wherein the body control module recognizes a tire equipped with the angular velocity sensor transmitting the (−) angular velocity signal as a right tire and a tire equipped with the angular velocity sensor transmitting the (+) angular velocity signal as a left tire.

4. The tire autolocation system using an angular velocity sensor as set forth in claim 1, wherein the body control module controls a tire pressure monitoring system as a sleep mode when the magnitude of the angular velocity signal transmitted from the angular velocity sensor is a reference value or less and wakeups the pressure monitoring system when the magnitude of the angular velocity signal exceeds a reference value.

5. The tire autolocation system using an angular velocity sensor as set forth in claim 1, wherein the body control module detects a radius of the tire by using an air pressure measuring signal transmitted from the air pressure detecting module, measures the revolutions of the tire by using the magnitude of the angular velocity signal transmitted from the angular velocity sensor, and measures velocity of a car by using the radius and revolutions of the tire.

6. A tire autolocation system using an angular velocity sensor, comprising:
an air pressure detector that includes an air pressure detecting module detecting air pressure of a tire and angular velocity sensors detecting angular velocity of the tire mounted to be symmetrical left and right; and
a body control module that includes a receiver and detects a radius of the tire by using an air pressure measuring signal transmitted from the air pressure detecting module through the receiver, measures the revolutions of the tire by using the magnitude of the angular velocity signal transmitted from the angular velocity sensor, and measures velocity of a car by using the radius and revolutions of the tire.

7. A tire autolocation system using an angular velocity sensor, comprising:
an air pressure detector that includes an air pressure detecting module detecting air pressure of a tire and angular velocity sensors detecting angular velocity of the tire mounted to be symmetrical left and right; and
a body control module that includes a receiver and controls a tire pressure monitoring system as a sleep mode when the magnitude of the angular velocity signal transmitted from the angular velocity sensor through the receiver is a reference value or less and wakeups the pressure monitoring system when the magnitude of the angular velocity signal exceeds a reference value.

8. A tire autolocation method using an angular velocity sensor, comprising:
(a) detecting whether the tire is rotated by the angular velocity sensor, when a car starts;
(b) measuring the angular velocity of the tire by the angular velocity sensor, when the tire rotates;
(c) detecting the left and right locations of the tire according to (+) and (−) signal signs of the angular velocity measured by the body control module.

9. The tire autolocation method using an angular velocity sensor as set forth in claim 8, where step (a) further includes repeating step (a) when the tire is not rotated.

10. The tire autolocation method using an angular velocity sensor as set forth in claim 8, wherein step (c) further includes recognizing a tire equipped with the angular velocity sensor transmitting the (+) angular velocity signal as a right tire and a tire equipped with the angular velocity sensor transmitting the (−) angular velocity signal as a left tire.

11. The tire autolocation method using an angular velocity sensor as set forth in claim 8, wherein step (c) further includes recognizing a tire equipped with the angular velocity sensor transmitting the (−) angular velocity signal as a right tire and a tire equipped with the angular velocity sensor transmitting the (+) angular velocity signal as a left tire.

12. The tire autolocation method using an angular velocity sensor as set forth in claim 8, further comprising:
(d) detecting, by the body control module, a radius of the tire by using an air pressure measuring signal transmitted from the air pressure detecting module;
(e) detecting, by the body control module, revolutions of the tire by using the magnitude of the angular velocity signal transmitted from the angular velocity sensor; and
(f) measuring, by the body control module, velocity of a car by using the radius and revolutions of the tire.
